(19) United States
(12) Patent Application Publication
(10) Pub. No.: US 2026/0054490 A1
(43) Pub. Date: Feb. 26, 2026

(54) LIQUID STORAGE UNIT, LIQUID SUPPLY UNIT, AND LIQUID EJECTION DEVICE

(71) Applicant: SEIKO EPSON CORPORATION, Tokyo (JP)

(72) Inventor: Chikashi NAKAMURA, AZUMINO-SHI (JP)

(21) Appl. No.: 19/308,570

(22) Filed: Aug. 25, 2025

(30) Foreign Application Priority Data
Aug. 26, 2024 (JP) 2024-144083

(51) Int. Cl. B41J 2/175

(52) U.S. Cl. CPC B41J 2/17566; B41J 2/17596; B41J 2002/17576

(57) ABSTRACT

A liquid storage unit configured to store a liquid includes: an injection port through which to inject the liquid; a cover part configured to open and close the injection port; an outflow port through which to allow the liquid in the liquid storage unit to flow out; a float valve changing in position according to a remaining amount of the liquid in the liquid storage unit, the float valve being configured to close the outflow port when the remaining amount of the liquid is in an end state; and a coupling part having a length in a vertical direction and configured to couple the cover part and the float valve, wherein the float valve moves from a closing position for closing the outflow port to an opening position for opening the outflow port, as the cover part moves from a closed position to an open position.

The present application is based on, and claims priority from JP Application Serial Number 2024-144083, filed Aug. 26, 2024, the disclosure of which is hereby incorporated by reference herein in its entirety.

### BACKGROUND

### 1. Technical Field

The present disclosure relates to a liquid storage unit, a liquid supply unit, and a liquid ejection device.

### 2. Related Art

For example, as disclosed in Japanese JP-A-2016-193616, there is an ink supply device, which is an example of a liquid supply unit. The ink supply device includes an ink containing part, an ink flow path, and a float valve. The ink containing part contains ink injected from an ink injection port, which is an example of an injection port. The ink containing part feeds ink from a communication port, which is an example of an outflow port, to the ink flow path.

The float valve is provided in the ink containing part. When the ink containing part is sufficiently filled with ink, the float valve floats up and thus opens the communication port. The float valve closes the communication port when the remaining amount of ink decreases.

JP-A-2016-193616 is an example of the related art.

The ink supply device disclosed in JP-A-2016-193616 applies a negative pressure to the ink flow path and thus sucks ink out of the ink containing part. Therefore, there is a risk that the float valve closing the communication port may stick to the communication port.

### SUMMARY

According to an aspect of the present disclosure, a liquid storage unit configured to store a liquid includes: an injection port through which to inject the liquid; a cover part configured to open and close the injection port; an outflow port through which to allow the liquid in the liquid storage unit to flow out; a float valve changing in position according to a remaining amount of the liquid in the liquid storage unit, the float valve being configured to close the outflow port when the remaining amount of the liquid is in an end state; and a coupling part having a length in a vertical direction and configured to couple the cover part and the float valve, wherein the float valve moves from a closing position for closing the outflow port to an opening position for opening the outflow port, as the cover part moves from a closed position to an open position.

According to another aspect of the present disclosure, a liquid supply unit includes: the liquid storage unit having the above configuration; a supply flow path through which the liquid flows out from the liquid storage unit; and a supply pump provided in the supply flow path.

According to still another aspect of the present disclosure, a liquid ejection device includes: the liquid supply unit having the above configuration; and a liquid ejection unit configured to eject the liquid.

### BRIEF DESCRIPTION OF THE DRAWINGS

FIG. 1 is a schematic view of a liquid ejection device according to a first embodiment.

FIG. 2 is a schematic view of a liquid storage unit according to the first embodiment.

FIG. 3 is a schematic view of the liquid storage unit according to the first embodiment.

FIG. 4 is a schematic view of the liquid storage unit according to the first embodiment.

FIG. 5 is a schematic view of a liquid storage unit according to a second embodiment.

FIG. 6 is a schematic view of the liquid storage unit according to the second embodiment.

FIG. 7 is a schematic view of the liquid storage unit according to the second embodiment.

FIG. 8 is a schematic view of a liquid storage unit according to a third embodiment.

FIG. 9 is a schematic view of the liquid storage unit according to the third embodiment.

FIG. 10 is a schematic view of the liquid storage unit according to the third embodiment.

FIG. 11 is a schematic view of the liquid storage unit according to the third embodiment.

FIG. 12 is a schematic view of a lead-out unit according to a fourth embodiment.

FIG. 13 is a schematic view of the lead-out unit according to the fourth embodiment.

FIG. 14 is a schematic view of the lead-out unit according to the fourth embodiment.

FIG. 15 is a schematic view of the lead-out unit according to the fourth embodiment.

FIG. 16 is a schematic view of the lead-out unit according to the fourth embodiment.

FIG. 17 is a schematic view of the lead-out unit according to the fourth embodiment.

FIG. 18 is a schematic view of the lead-out unit according to the fourth embodiment.

FIG. 19 is a schematic view of the lead-out unit according to the fourth embodiment.

FIG. 20 is a schematic view of the lead-out unit according to the fourth embodiment.

FIG. 21 is a schematic view of the lead-out unit according to the fourth embodiment.

FIG. 22 is a schematic view of the lead-out unit according to the fourth embodiment.

### DESCRIPTION OF EMBODIMENTS

### First Embodiment

Hereinafter, a liquid storage unit, a liquid supply unit, and a liquid ejection device according to a first embodiment will be described with reference to the drawings. The liquid ejection device is, for example, an inkjet printer that ejects ink, which is an example of a liquid, onto a medium such as paper, fabric, vinyl, plastic component, or metal component to perform printing.

### Liquid Ejection Device

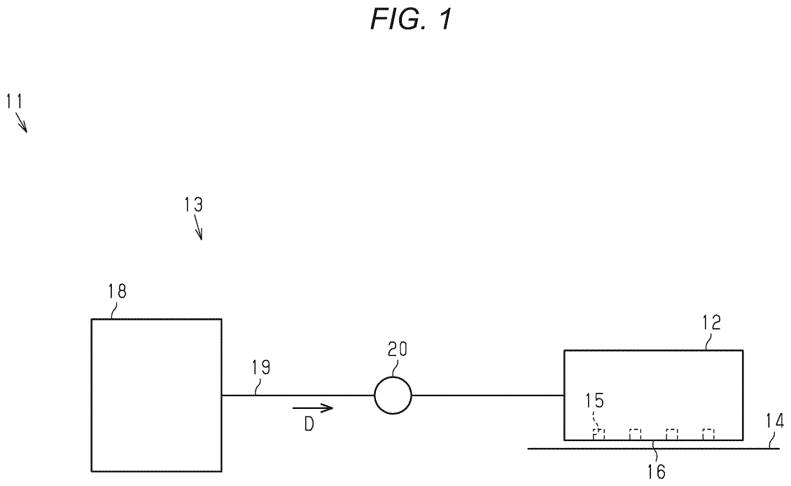

As illustrated in FIG. 1, a liquid ejection device 11 includes a liquid ejecting unit 12 and a liquid supply unit 13.

The liquid ejection unit 12 can eject a liquid. The liquid ejection unit 12 ejects a liquid onto a medium 14 and thus performs printing on the medium 14. The liquid ejection unit 12 has a nozzle surface 16 where one or more nozzles 15 open. The liquid ejection unit 12 ejects a liquid from the nozzle 15.

### Liquid Supply Unit

The liquid supply unit 13 may include a liquid storage unit 18, a supply flow path 19, and a supply pump 20.

The liquid storage unit 18 can store a liquid.

An upstream end of the supply flow path 19 in a supply direction D is coupled to the liquid storage unit 18. The supply flow path 19 allows the liquid to flow out from the liquid storage unit 18. A downstream end of the supply flow path 19 in the supply direction D is coupled to the liquid ejection unit 12. The supply flow path 19 supplies the liquid stored in the liquid storage unit 18 to the liquid ejection unit 12.

The supply pump 20 is provided in the supply flow path 19. The supply pump 20 supplies the liquid sucked from the liquid storage unit 18 to the liquid ejection unit 12. The supply pump 20 may be, for example, a diaphragm pump, a tube pump, a gear pump, or a piston pump.

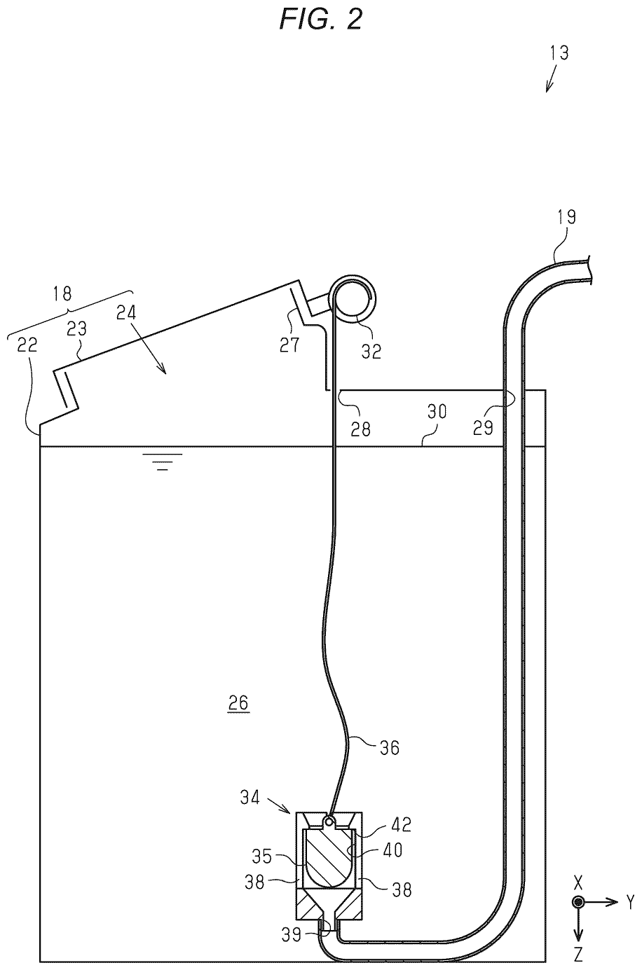

As shown in FIG. 2, in the drawings, assuming that the liquid supply unit 13 is placed on a horizontal plane, the direction of gravity is indicated by a Z axis, and directions along the horizontal plane are indicated by an X axis and a Y axis. The X axis, the Y axis, and the Z axis are orthogonal to each other. In the description below, a direction parallel to the X axis is also referred to as a width direction X, a direction parallel to the Y axis is also referred to as a depth direction Y, and a direction parallel to the Z axis is also referred to as a vertical direction Z.

### Liquid Storage Unit

As illustrated in FIG. 2, the liquid storage unit 18 may include a main body 22, a cover part 23, and a lead-out unit 24.

The main body 22 may include a storage chamber 26, an injection port 27, a connection port 28, and a supply port 29.

The storage chamber 26 stores the liquid injected from the injection port 27. The position of a liquid surface 30 of the liquid stored in the storage chamber 26 changes according to the remaining amount.

The injection port 27, the connection port 28, and the supply port 29 connect the storage chamber 26 to the outside. The injection port 27, the connection port 28, and the supply port 29 in the present embodiment are located above the liquid surface 30 in a state where the maximum amount of liquid is stored in the storage chamber 26. The liquid can be injected through the injection port 27. The connection port 28 is provided to pass a coupling part 36 therethrough. The supply port 29 is provided to pass, for example, a tube forming the supply flow path 19 therethrough.

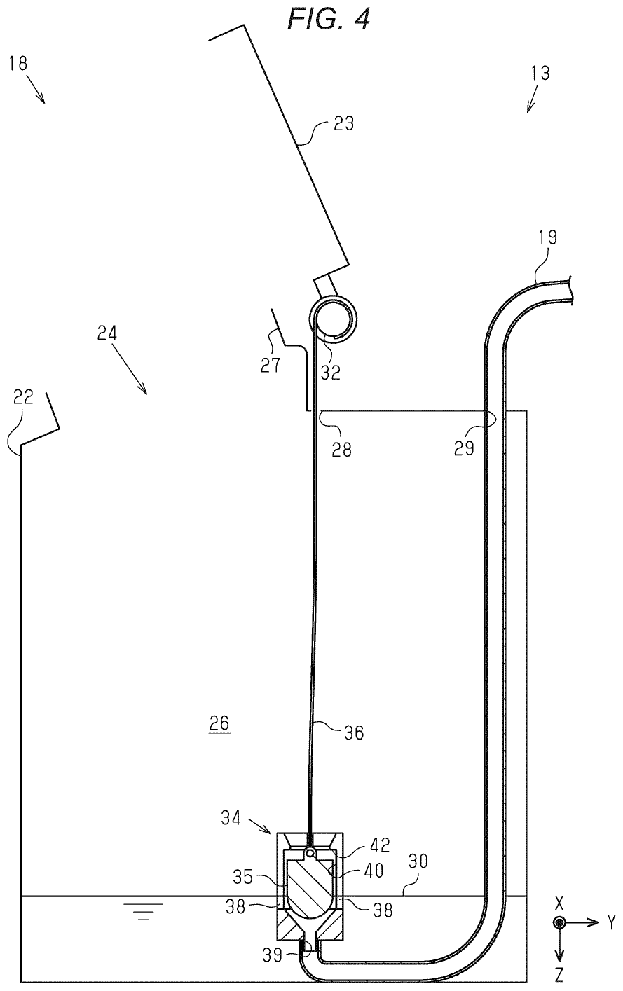

The cover part 23 includes a rotation shaft 32. The rotation shaft 32 may be rotatably supported by the main body 22. The cover part 23 is displaced by rotating about the rotation shaft 32. The cover part 23 is displaceable between a closed position shown in FIG. 2 and an open position shown in FIG. 4. The closed position is a position for closing the injection port 27. The open position is a position for opening the injection port 27. The cover part 23 opens and closes the injection port 27. When the cover part 23 is positioned at the open position, the liquid can be injected from the injection port 27. The rotation shaft 32 may be provided at a rear end of the cover part 23 in the depth direction Y. When the rotation shaft 32 is positioned to the rear side, the user can easily inject the liquid into the injection port 27 from the front side.

### Lead-Out Unit

The lead-out unit 24 may be provided in the storage chamber 26. The lead-out unit 24 may include a holder 34, a float valve 35, and the coupling part 36.

The holder 34 holds the float valve 35 in a movable state. The holder 34 is, for example, cylindrical. The holder 34 may include an inflow part 38, an outflow port 39, and a guide part 40.

The holder 34 may have a plurality of inflow parts 38. The inflow part 38 may be a slit extending in the vertical direction Z from the upper end of the holder 34. The inflow part 38 is located above the outflow port 39.

The outflow port 39 opens at a lower part of the holder 34. The outflow port 39 is located below the float valve 35. The upstream end of the supply flow path 19 is coupled to the outflow port 39. The supply flow path 19 may be inserted into the storage chamber 26 from the supply port 29, and the upstream end thereof may be coupled to the outflow port 39. The outflow port 39 allows the liquid in the liquid storage unit 18 to flow out.

The guide part 40 guides the movement of the float valve 35. The guide part 40 is, for example, an inner circumferential surface of the holder 34. The guide part 40 may include a regulation part 42. The regulation part 42 regulates the range of movement of the float valve 35. The regulation part 42 is, for example, a claw protruding inward from the inner circumferential surface of the holder 34. The regulation part 42 keeps the float valve 35 in the holder 34. The regulation part 42 is in contact with the float valve 35 and thus suppresses the float valve 35 from coming out of the holder 34. The regulation part 42 may be located at the upper end of the holder 34.

The float valve 35 is configured to be able to open and close the outflow port 39. The specific gravity of the float valve 35 is lower than the specific gravity of the liquid stored in the liquid storage unit 18. Therefore, the float valve 35 floats on the liquid. The float valve 35 is a valve that changes in position according to the remaining amount of the liquid in the liquid storage unit 18. The float valve 35 moves up and down according to the remaining amount of the liquid.

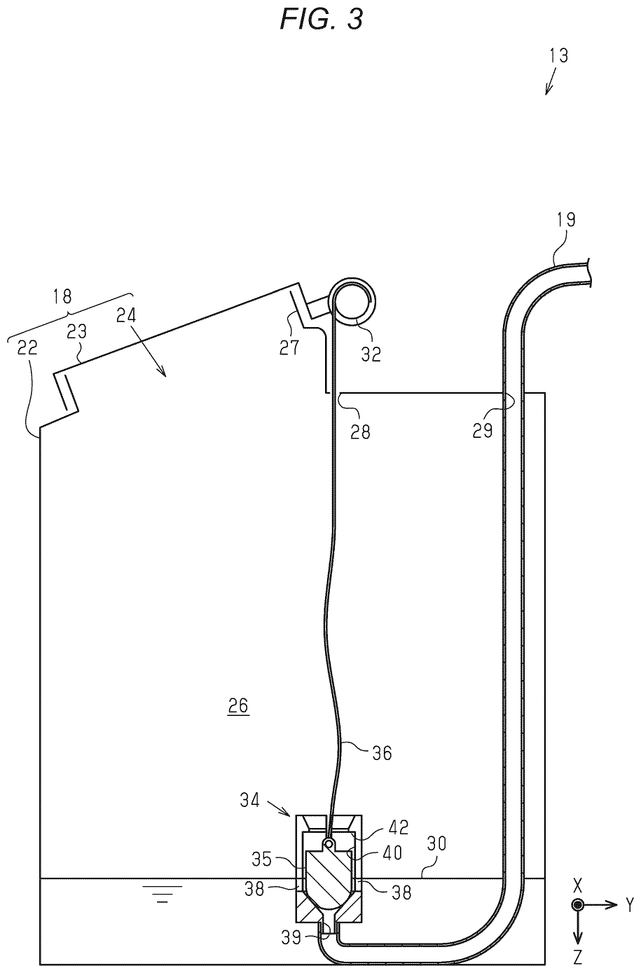

The float valve 35 is movable between an opening position shown in FIG. 2 and a closing position shown in FIG. 3. The opening position is a position away from the outflow port 39. When the float valve 35 is located at the opening position, the outflow port 39 communicates with the inflow part 38. The opening position is a position for opening the outflow port 39. The closing position is a position below the opening position. When the float valve 35 is located at the closing position, the outflow port 39 is separated from the inflow part 38. The closing position is a position for closing the outflow port 39.

The coupling part 36 couples the cover part 23 and the float valve 35. The coupling part 36 in the present embodiment has a lower end coupled to the float valve 35 and an upper end coupled to the rotation shaft 32. The coupling part 36 is provided so as to be able to be wound up around the rotation shaft 32. At least a part of the coupling part 36 wound up around the rotation shaft 32 has flexibility. The coupling part 36 may be formed of, for example, a thread, a string, a rope, a chain, a wire, or the like, or may be formed of a combination of these. The coupling part 36 passes through the connection port 28. The coupling part 36 has a length along the vertical direction Z. In the vertical direction Z, the length of the coupling part 36 is longer than the length from the rotation shaft 32 to the float valve 35.

### Functions of First Embodiment

The functions of the present embodiment will be described.

As illustrated in FIG. 2, when the remaining amount of the liquid is sufficient, the float valve 35 floats up and comes into contact with the regulation part 42. That is, the float valve 35 is located at the opening position. The separation of the float valve 35 from the outflow port 39 is also referred to as the opening of the float valve 35. When the float valve 35 is opened, the liquid can be led out from the storage chamber 26 to the supply flow path 19.

As illustrated in FIG. 3, when the liquid is led out from the storage chamber 26, the liquid surface 30 is lowered. The float valve 35 descends together with the liquid surface 30. The float valve 35 closes the outflow port 39 when the remaining amount of the liquid reaches an end state. The end state is a state where the remaining amount of the liquid is small. In the end state, the liquid surface 30 is located above the outflow port 39. In the present embodiment, the closing of the outflow port 39 by the float valve 35 is also referred to as the closing of the float valve 35. When the float valve 35 is closed, the liquid cannot be led out from the storage chamber 26 to the supply flow path 19.

When the supply pump 20 is driven in the state where the float valve 35 is closed, the negative pressure upstream of the supply pump 20 increases. When the negative pressure acts on the float valve 35 closing the outflow port 39, the float valve 35 is less likely to float up.

As shown in FIG. 4, the float valve 35 moves from the closing position to the opening position as the cover part 23 moves from the closed position to the open position. Specifically, when the cover part 23 located at the closed position is displaced to the open position, the rotation shaft 32 rotates together with the cover part 23. The coupling part 36 is wound up around the rotary shaft 32 and pulls up the float valve 35. Therefore, the float valve 35 moves from the closing position and opens the outflow port 39.

When the cover part 23 moves to the open position, the injection port 27 is opened and thus the liquid can be injected. When the liquid is injected, the float valve 35 floats up due to its own buoyancy, and the float valve 35 comes into contact with the regulation part 42 and is thus restricted from moving.

### Effects of First Embodiment

The effects of the present embodiment will be described.

(1-1) The coupling part 36 couples the cover part 23 and the float valve 35. Since the coupling part 36 moves the float valve 35 with the movement of the cover part 23, the outflow port 39 can be opened without relying on the buoyancy of the float valve 35. Therefore, it is not necessary to generate, in the float valve 35, a buoyancy higher than the negative pressure acting on the float valve 35 closing the outflow port 39. Thus, for example, even when a small float valve 35 is used, the risk of the outflow port 39 being left closed can be reduced and therefore an increase in size can be suppressed.

(1-2) The cover rotates about the rotation shaft 32 and thus winds up the coupling part 36. The coupling part 36, thus wound up, can pull up the float valve 35. Therefore, the sticking of the float valve 35 can be released with a simple configuration.

(1-3) The guide part 40 guides the movement of the float valve 35. The guide part 40 includes the regulation part 42. The regulation part 42 regulates the range of movement of the float valve 35. Therefore, the risk of the float valve 35 being detached from the guide part 40 can be reduced.

### Second Embodiment

Next, a liquid storage unit, a liquid supply unit, and a liquid ejection device according to a second embodiment will be described with reference to the drawings. The second embodiment is different from the first embodiment in the liquid supply unit. Since the other parts of the second embodiment are substantially the same as those of the first embodiment, the same components are denoted by the same reference numerals and a repeated description thereof will be omitted.

### Liquid Supply Unit

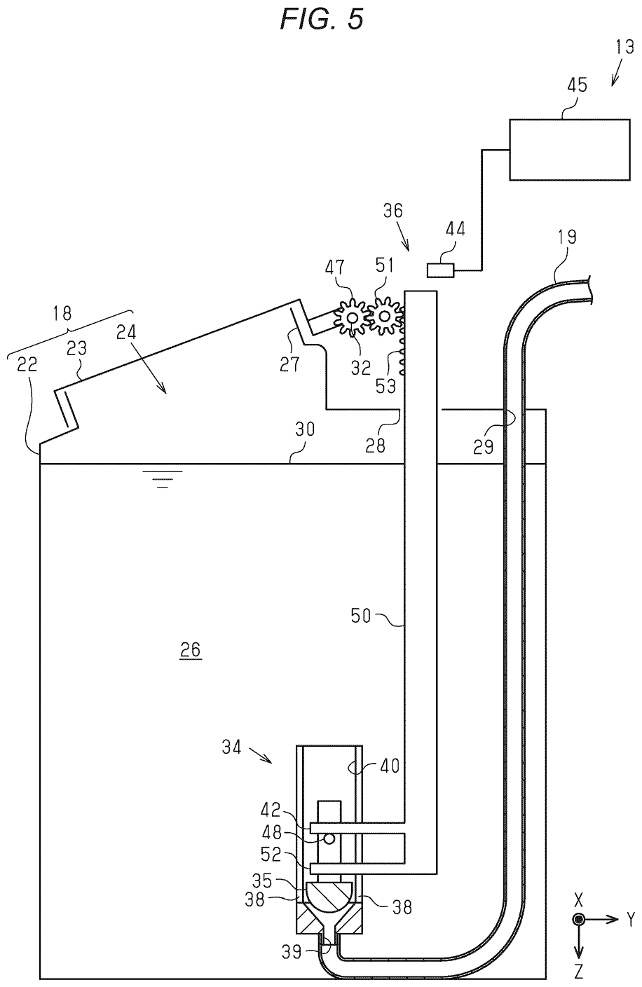

As illustrated in FIG. 5, the liquid supply unit 13 may include a detection unit 44 and a control unit 45.

The detection unit 44 detects the opening and closing of the cover part 23. The detection unit 44 may detect the position of the coupling part 36 and thus indirectly detect the opening and closing of the cover part 23. The detection unit 44 is, for example, a photoelectric sensor. The detection unit 44 may detect the position of the coupling part 36, based on whether emitted light is blocked.

The control unit 45 may control the supply pump 20. The control unit 45 may comprehensively control the driving of each mechanism in the liquid supply unit 13 and control various operations executed by the liquid supply unit 13. The control unit 45 may comprehensively control the driving of each mechanism in the liquid ejection device 11 and control various operations executed in the liquid ejection device 11.

The control unit 45 can be configured as a circuit including α: one or more processors that execute various kinds of processing in accordance with a computer program, β: one or more dedicated hardware circuits that execute at least a part of the various kinds of processing, or γ: a combination of α and β. The hardware circuit is, for example, an application-specific integrated circuit. The processor includes a CPU and a memory such as a RAM and a ROM, and the memory stores program codes or commands configured to cause the CPU to execute the processing. The memory, that is, a computer-readable medium, includes any readable medium that can be accessed by a general-purpose or dedicated computer.

The cover part 23 may include a first engaged part 47. The first engaged part 47 is, for example, a gear that rotates about the rotation shaft 32. The first engaged part 47 rotates as the cover part 23 is displaced between the open position and the closed position.

The float valve 35 may have a second engaged part 48. The second engaged part 48 in the present embodiment is a protrusion.

The coupling part 36 may include a rod part 50, a first engaging part 51, a second engaging part 52, a rack 53, and a regulation part 42.

The rod part 50 has a length along the vertical direction Z. The rod part 50 may have rigidity. The rod part 50 passes through the connection port 28. The second engaging part 52, the rack 53, and the regulation part 42 may be provided at the rod part 50.

The first engaging part 51 engages with the first engaged part 47. The first engaging part 51 is a gear that meshes with the first engaged part 47. The rack 53 meshes with the first engaging part 51. The rack 53 may be located at an upper end part of the rod part 50. The first engaged part 47, the first engaging part 51, and the rack 53 are located outside the storage chamber 26. The first engaging part 51 transmits the rotation of the cover part 23 to the rod part 50. Therefore, when the cover part 23 is opened and closed, the rod part 50 moves. The rod part 50 may move back and forth in the vertical direction Z.

The second engaging part 52 may be located at a lower end part of the rod part 50. The second engaging part 52 is located below the second engaged part 48. The second engaging part 52 is engageable with the second engaged part 48.

The regulation part 42 may be located between the second engaging part 52 and the rack 53. The regulation part 42 is located above the second engaged part 48. The second engaged part 48 is located between the second engaging part 52 and the regulation part 42.

### Functions of Second Embodiment

The functions of the present embodiment will be described.

As illustrated in FIG. 5, when the remaining amount of the liquid is sufficient, the float valve 35 floats up and comes into contact with the regulation part 42. That is, the float valve 35 is located at the opening position. When the float valve 35 is opened, the liquid can be led out from the storage chamber 26 to the supply flow path 19.

When the cover part 23 is located at the closed position, the control unit 45 drives the supply pump 20. When the cover part 23 is located at the closed position, the rod part 50 is located below the detection unit 44. Therefore, the detection unit 44 does not detect the coupling part 36. When the detection unit 44 does not detect the coupling part 36, the control unit 45 may determine that the cover part 23 is located at the closed position, and drive the supply pump 20.

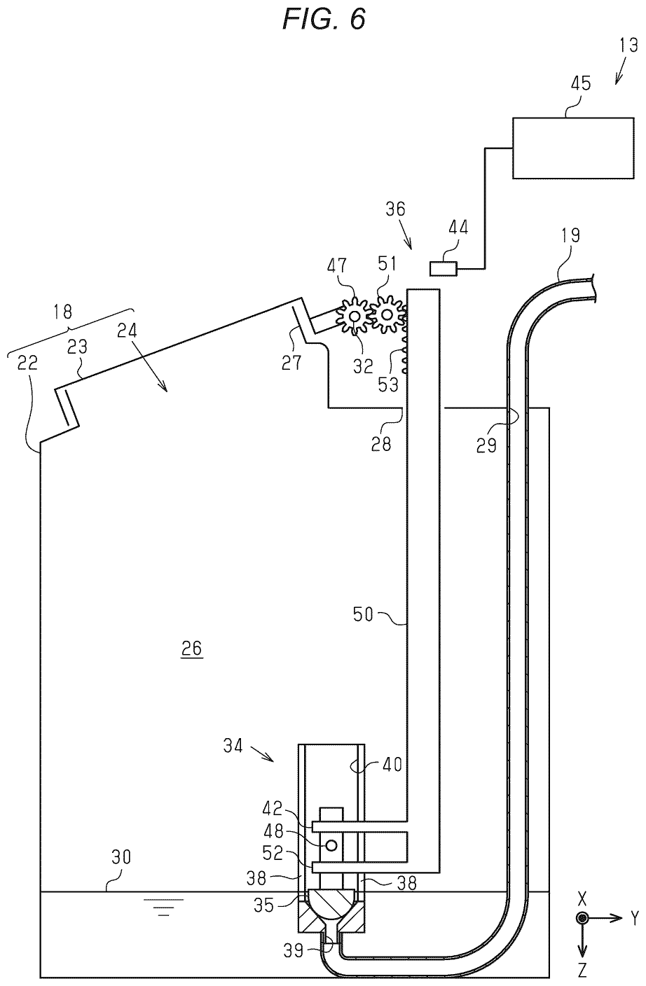

As illustrated in FIG. 6, when the liquid is led out from the storage chamber 26, the liquid surface 30 is lowered. The float valve 35 descends together with the liquid surface 30. The float valve 35 closes the outflow port 39 when the remaining amount of the liquid reaches the end state. When the float valve 35 is closed, the liquid cannot be led out from the storage chamber 26 to the supply flow path 19. The negative pressure by the supply pump 20 acts on the float valve 35 located at the closing position.

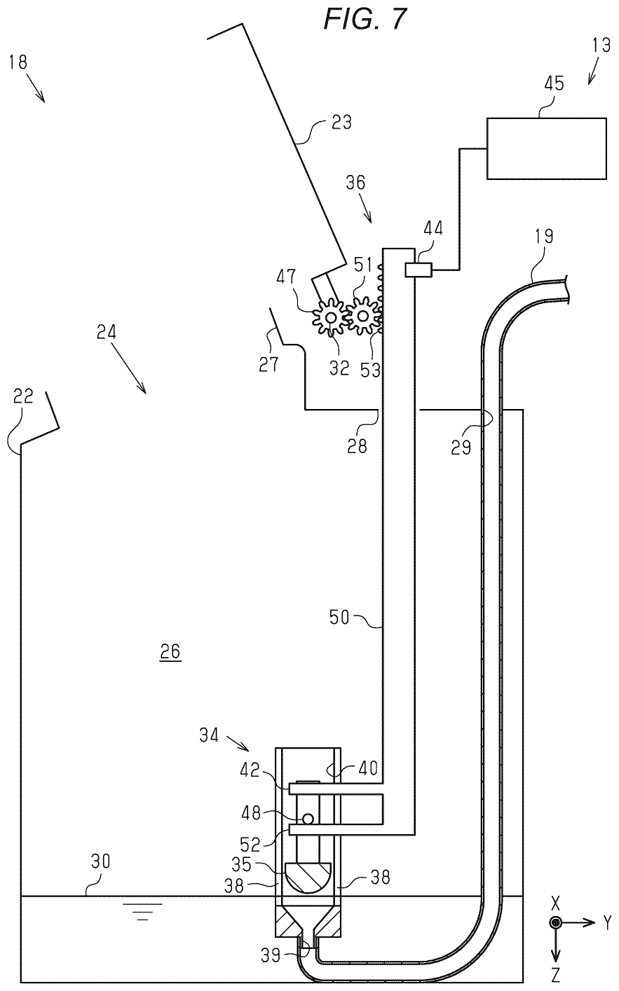

As illustrated in FIG. 7, the float valve 35 moves from the closing position to the opening position as the cover part 23 moves from the closed position to the open position. Specifically, when the cover part 23 located at the closed position moves to the open position, the first engaged part 47 rotates clockwise in FIG. 7. When the rotation of the first engaged part 47 is transmitted to the rod part 50 via the first engaging part 51 and the rack 53, the rod part 50 rises. At this time, the second engaging part 52 lifts up the second engaged part 48. Therefore, the float valve 35 moves from the closing position and opens the outflow port 39.

When the cover part 23 is located at the open position, the detection unit 44 detects the rod part 50. The control unit 45 causes the detection unit 44 to detect the coupling part 36 and thus indirectly detects that the cover part 23 is located at the open position. When the detection unit 44 detects that the cover part 23 is located at the open position, the control unit 45 does not drive the supply pump 20. Therefore, the supply of the liquid from the liquid storage unit 18 is stopped.

When the liquid is injected, the float valve 35 floats up due to its own buoyancy, and the float valve 35 comes into contact with the regulation part 42 and is thus restricted from moving.

As shown in FIG. 5, when the cover part 23 moves from the open position to the closed position, the first engaged part 47 rotates counterclockwise in FIG. 5. When the rotation of the first engaged part 47 is transmitted to the rod part 50 via the first engaging part 51 and the rack 53, the rod part 50 descends. At this time, the regulation part 42 pushes down the second engaged part 48. When the descending rod part 50 is detached from the detection unit 44, the control unit 45 may determine that the cover part 23 is moved from the open position, and drive the supply pump 20.

### Effects of Second Embodiment

The effects of the present embodiment will be described.

(2-1) The coupling part 36 is engaged with the cover part 23 and the float valve 35 by the first engaging part 51 and the second engaging part 52. Therefore, the sticking of the float valve 35 can be released with a simple configuration.

(2-2) The first engaged part 47 of the cover part 23 is a gear. The first engaging part 51 of the coupling part 36 is a gear that meshes with the first engaged part 47. The first engaging part 51 meshes with the rack 53 of the coupling part 36. That is, the coupling part 36 moves when the rotation of the cover is transmitted via the first engaged part 47, the first engaging part 51, and the rack 53. Therefore, the sticking of the float valve 35 can be released with a simple configuration.

(2-3) When the cover part 23 is located at the open position, the float valve 35 may not be able to close the outflow port 39. In this regard, when the cover part 23 is located at the open position, the control unit 45 does not drive the supply pump 20. Therefore, the risk that the supply pump 20 may suck out the air from the liquid storage unit 18 can be reduced.

### Third Embodiment

Next, a liquid storage unit, a liquid supply unit, and a liquid ejection device according to a third embodiment will be described with reference to the drawings. The third embodiment is different from the first embodiment in the lead-out unit. Since the other parts of the third embodiment are substantially the same as those of the first embodiment, the same components are denoted by the same reference numerals and a repeated description thereof will be omitted.

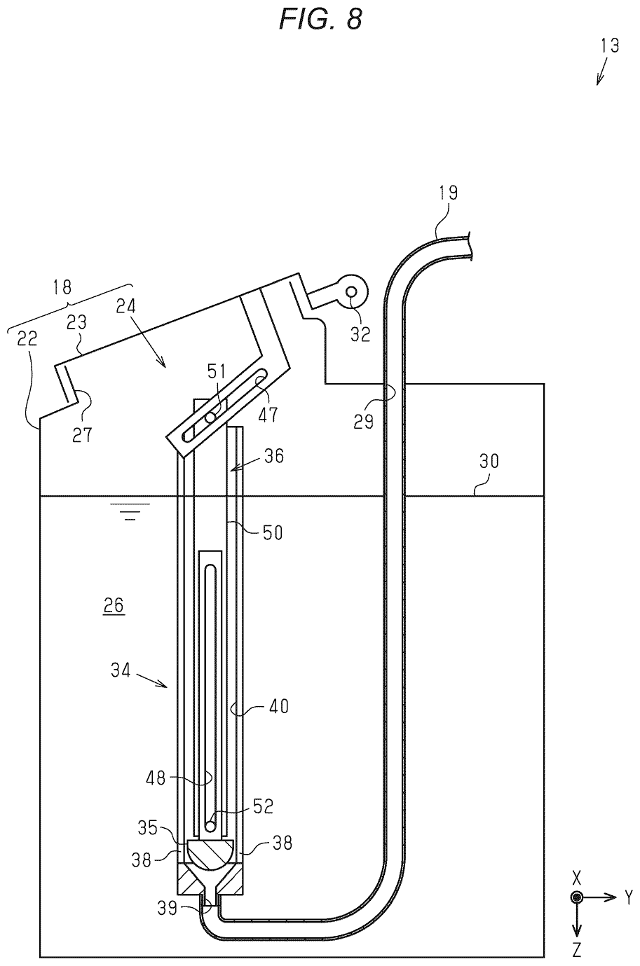

As shown in FIG. 8, the cover part 23 may have a first engaged part 47. The first engaged part 47 in the present embodiment is an elongated hole.

The float valve 35 may have a second engaged part 48. The second engaged part 48 in the present embodiment is an elongated hole.

The coupling part 36 may include a rod part 50, a first engaging part 51, and a second engaging part 52.

The rod part 50 has a length along the vertical direction Z. The rod part 50 may have rigidity. The first engaging part 51 is a protrusion that is inserted into the first engaged part 47. The first engaging part 51 may be located at an upper end part of the rod part 50. The second engaging part 52 is a protrusion that is inserted into the second engaged part 48. The second engaging part 52 may be located at a lower end part of the rod part 50.

### Functions of Third Embodiment The functions of the present embodiment will be described.

As shown in FIG. 8, when the remaining amount of the liquid is sufficient, the float valve 35 floats up and moves away from the outflow port 39. The movement of the float valve 35 is restricted by the lower end of the second engaged part 48 coming into contact with the second engaging part 52. The float valve 35 is located at the opening position. When the float valve 35 is opened, the liquid can be led out from the storage chamber 26 to the supply flow path 19.

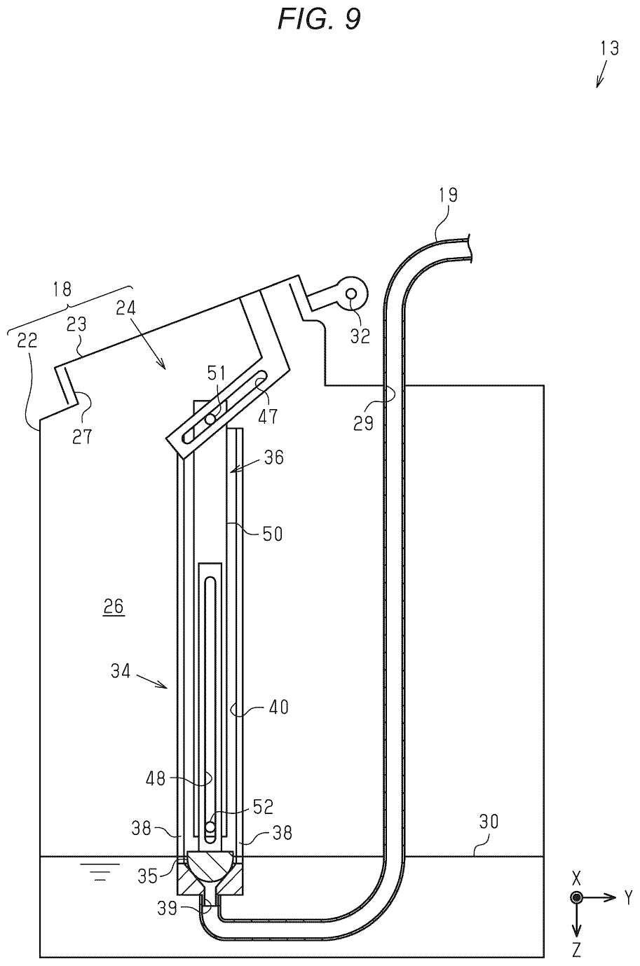

As illustrated in FIG. 9, when the liquid is led out from the storage chamber 26, the liquid surface 30 is lowered. The float valve 35 descends together with the liquid surface 30. The float valve 35 closes the outflow port 39 when the remaining amount of the liquid reaches the end state. When the float valve 35 is closed, the liquid cannot be led out from the storage chamber 26 to the supply flow path 19. The negative pressure by the supply pump 20 acts on the float valve 35 located at the closing position.

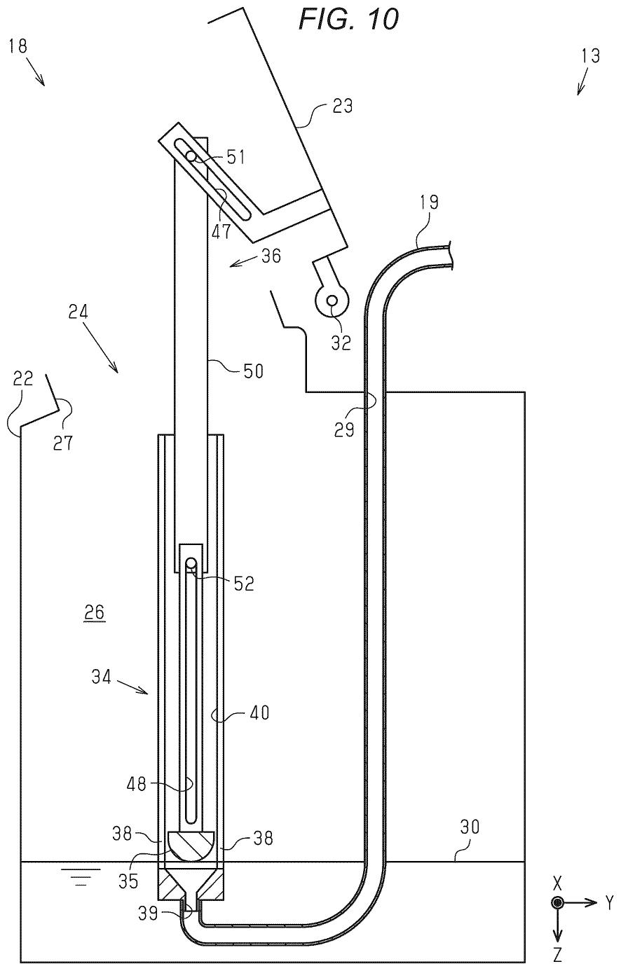

As shown in FIG. 10, the float valve 35 moves from the closing position to the opening position as the cover part 23 moves from the closed position to the open position. Specifically, when the cover part 23 located at the closed position moves to the open position, the first engaged part 47 pulls up the float valve 35 via the rod part 50. The float valve 35 moves from the closing position and opens the outflow port 39.

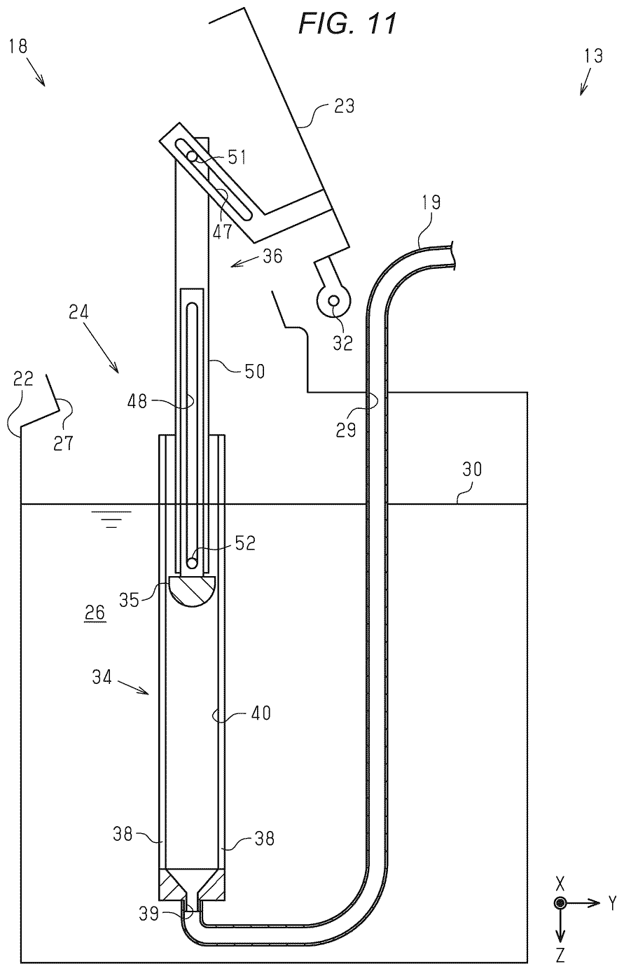

As shown in FIG. 11, when the liquid is injected, the float valve 35 floats up due to its own buoyancy. The movement of the float valve 35 is restricted by the lower end of the second engaged part 48 coming into contact with the second engaging part 52. When the cover part 23 moves from the open position to the closed position, the second engaging part 52 pushes down the second engaged part 48.

### Effects of Third Embodiment

The effects of the present embodiment will be described.

(3-1) The first engaging part 51 is movable along the first engaged part 47, which is an elongated hole. The second engaging part 52 is movable along the second engaged part 48, which is an elongated hole. Therefore, the float valve 35 can be moved in a direction different from the direction in which the cover part 23 moves.

### Fourth Embodiment

Next, a liquid storage unit, a liquid supply unit, and a liquid ejection device according to a fourth embodiment will be described with reference to the drawings. The fourth embodiment is different from the second and third embodiments in the lead-out unit. Since the other parts of the fourth embodiment are substantially the same as those of the other embodiments, the same components are denoted by the same reference numerals and a repeated description thereof will be omitted.

### Lead-Out Unit

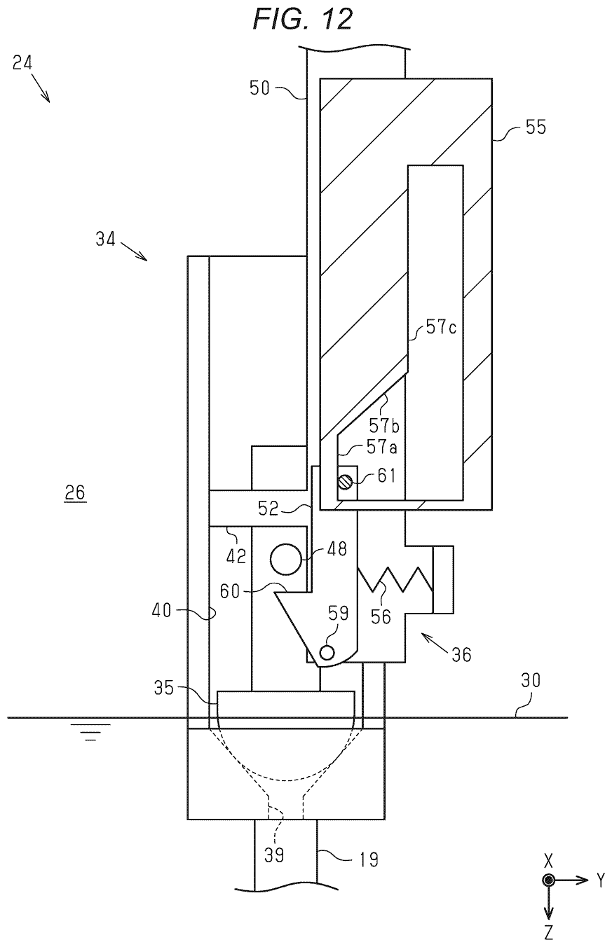

As shown in FIG. 12, the lead-out unit 24 may include a holder 34, a float valve 35, a coupling part 36, and a release part 55.

The float valve 35 may have a second engaged part 48. The second engaged part 48 in the present embodiment is a protrusion.

The coupling part 36 may include a rod part 50, a second engaging part 52, and an urging member 56.

The release part 55 may be fixed to the holder 34 or the main body 22. The release part 55 is provided so as not to be movable. The release part 55 may include a first guide surface 57a, a second guide surface 57b, and a third guide surface 57c.

The first guide surface 57a and the third guide surface 57c may be surfaces parallel to the vertical direction Z, which is the direction of movement of the rod part 50. The first guide surface 57a is located below the third guide surface 57c. In the depth direction Y, the distance from the first guide surface 57a to the second engaged part 48 is shorter than the distance from the third guide surface 57c to the second engaged part 48.

The second guide surface 57b may be a surface inclined in relation to the vertical direction Z. In the vertical direction Z and the depth direction Y, the second guide surface 57b is located between the first guide surface 57a and the third guide surface 57c.

The rod part 50 may include a regulation part 42 and a support shaft 59. The support shaft 59 is provided at a lower end part of the rod part 50. The support shaft 59 rotatably supports the second engaging part 52. The second engaging part 52 of the present embodiment is a claw for catching the second engaged part 48. The second engaging part 52 includes a claw part 60 and a guided part 61. The claw part 60 is engageable with the second engaged part 48. The guided part 61 is movable so as to slide in contact with the first to third guide surfaces 57a to 57c.

The urging member 56 is, for example, a compression coil spring. The urging member 56 urges the second engaging part 52. The urging member 56 pushes the second engaging part 52 toward the second engaged part 48 while being supported by the rod part 50. The urging member 56 presses the guided part 61 against the first to third guide surfaces 57a to 57c.

### Functions of Fourth Embodiment

The functions of the present embodiment will be described.

As shown in FIG. 12, when the remaining amount of the liquid is in the end state, the float valve 35 is located at the closing position. When the cover part 23 is located at the closed position, the claw part 60 is located below the second engaged part 48. When the cover part 23 is located at the closed position, the guided part 61 is pressed against the first guide surface 57a.

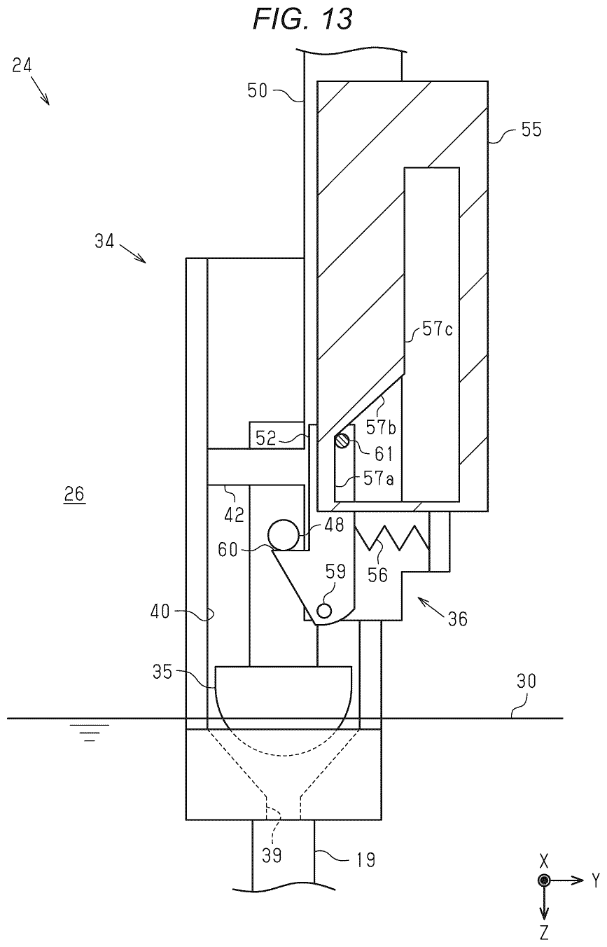

As shown in FIG. 13, the rod part 50 rises as the cover part 23 moves from the closed position to the open position. When the rod part 50 rises, both the second engaging part 52 and the urging member 56 rise. The second engaging part 52 lifts up the float valve 35 as the claw part 60 catches the second engaged part 48. The float valve 35 opens the outflow port 39. Therefore, even when the negative pressure is large in the supply flow path 19 between the float valve 35 and the supply pump 20, the negative pressure is eliminated by opening the outflow port 39.

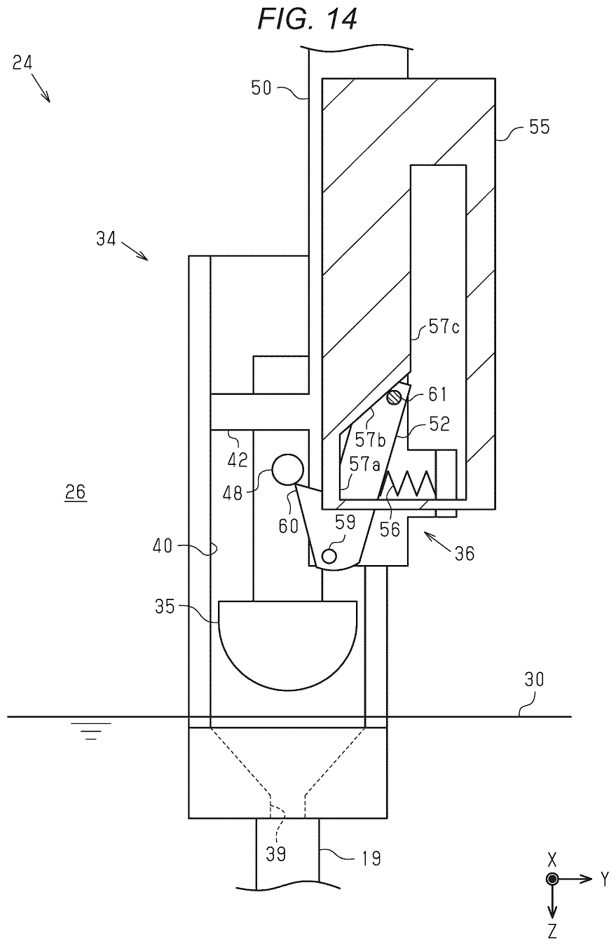

As shown in FIG. 14, when the rod part 50 rises further, the guided part 61 is guided by the second guide surface 57b. The second engaging part 52 rotates about the support shaft 59. The second engaging part 52 is inclined against the urging force of the urging member 56 so that the guided part 61 moves away from the second engaged part 48.

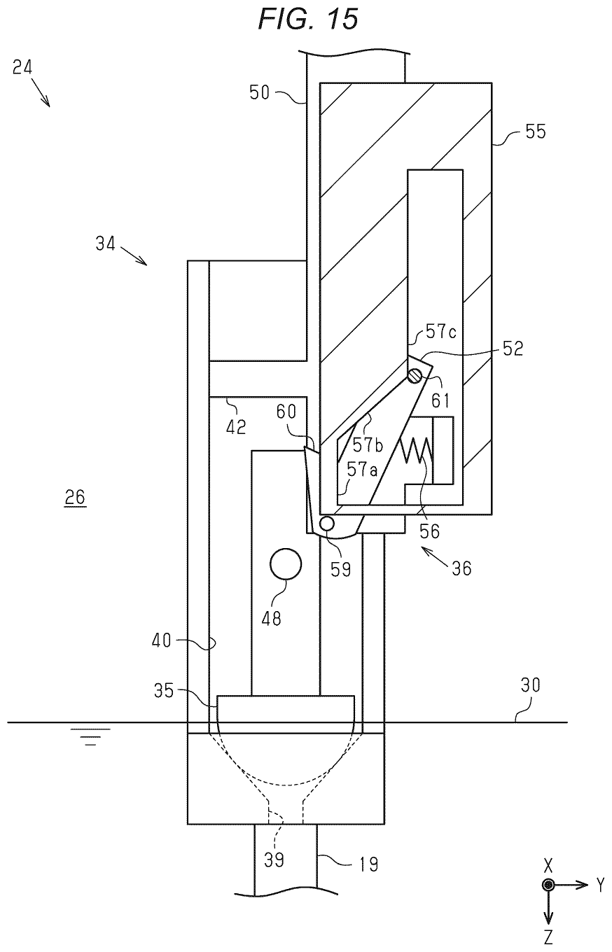

As shown in FIG. 15, when the cover part 23 moves from the closed position to the open position, the second engaging part 52 catches the second engaged part 48 to move the float valve 35 to the opening position, and then the engagement with the second engaged part 48 is released by the release part 55. The release part 55 moves the second engaging part 52 against the urging force of the urging member 56 and thus releases the engagement between the second engaging part 52 and the second engaged part 48. When the guided part 61 moves to the third guide surface 57c, the claw part 60 of the second engaging part 52 is disengaged from the second engaged part 48. The float valve 35 released from the engagement returns to the closing position, like falling. Even when the float valve 35 returns to the closing position, the float valve 35 can be easily displaced from the closing position since the negative pressure of the supply flow path 19 is eliminated.

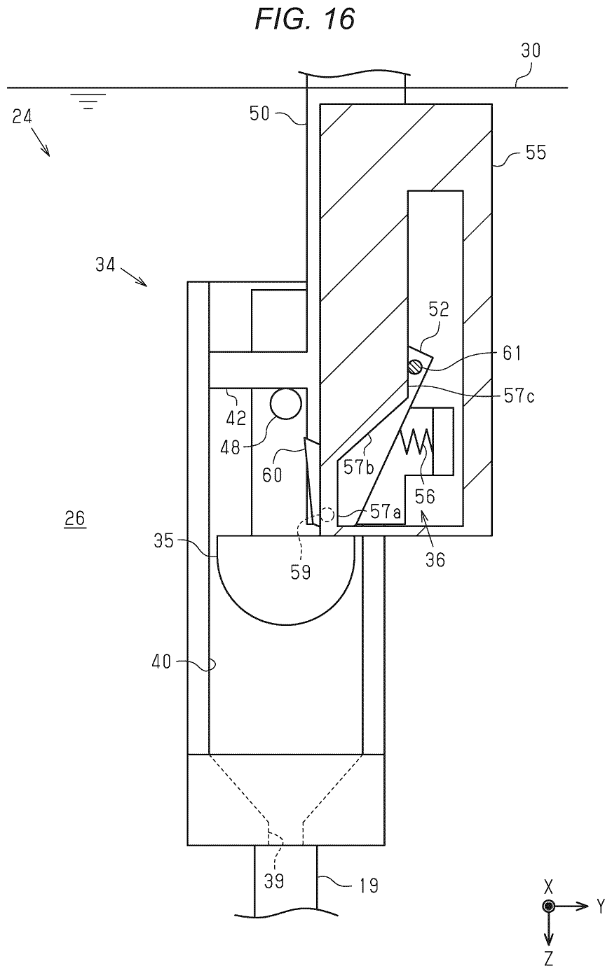

As shown in FIG. 16, when the cover part 23 is located at the open position, the claw part 60 is retracted from the movement path of the second engaged part 48. Therefore, when the liquid is injected into the storage chamber 26 and the liquid surface 30 rises, the float valve 35 floats up to a position where the second engaged part 48 comes into contact with the regulation part 42.

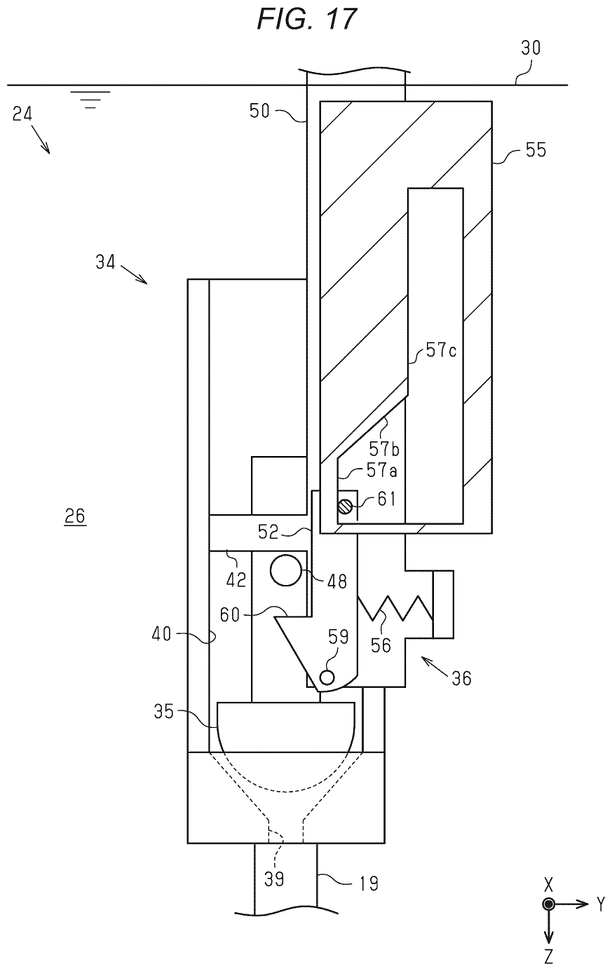

As shown in FIG. 17, the rod part 50 descends as the cover part 23 moves from the open position to the closed position. The rod part 50 brings the float valve 35 closer to the outflow port 39 as the regulation part 42 pushes down the second engaged part 48. When the cover part 23 is located at the closed position and the remaining amount of the liquid is sufficient, the float valve 35 opens the outflow port 39.

As illustrated in FIG. 16, for example, when printing is performed while the cover part 23 is located at the open position, the liquid flows out from the storage chamber 26 and the liquid surface 30 is lowered.

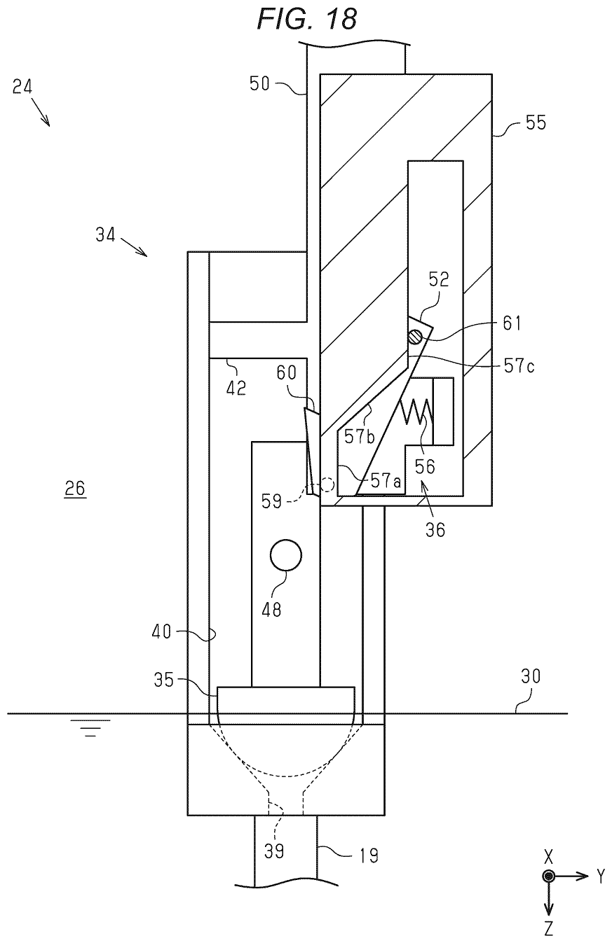

As shown in FIG. 18, when the cover part 23 is located at the open position, the claw part 60 is retracted from the movement path of the second engaged part 48. Therefore, the float valve 35 descends in accordance with the lowering of the liquid surface 30, and closes the outflow port 39 when the remaining amount of the liquid is in the end state.

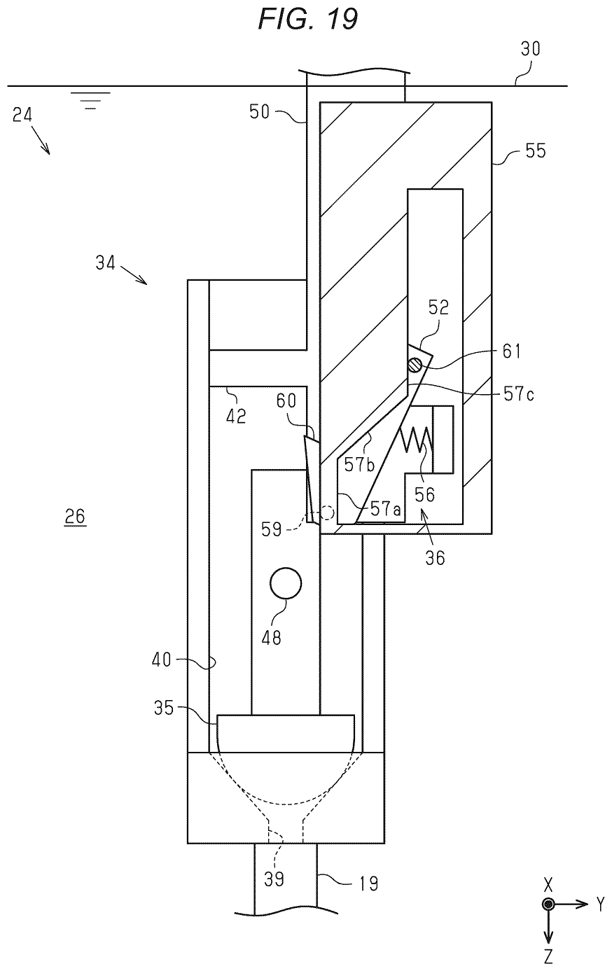

As shown in FIG. 19, the float valve 35 can move to the closing position even when the cover part 23 is located at the open position, but the float valve 35 moved to the closing position may stick due to the negative pressure of the supply flow path 19. Even when the liquid is injected and the liquid surface 30 rises, the sticking float valve 35 cannot float up and remains at the closing position. In this case, the user opens and closes the cover part 23.

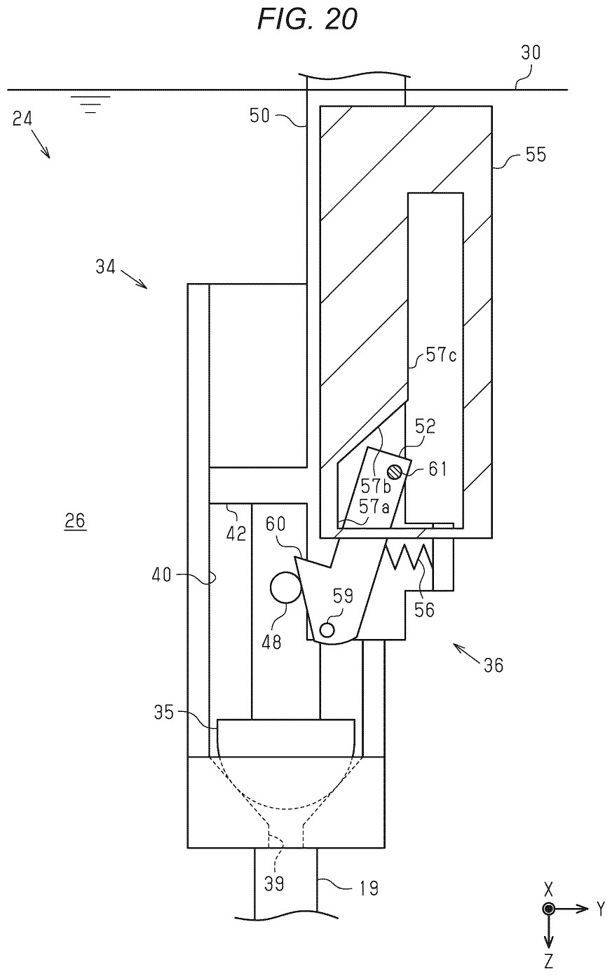

As shown in FIG. 20, the rod part 50 descends as the cover part 23 moves from the open position to the closed position. When the second engaging part 52 comes into contact with the second engaged part 48, the second engaging part 52 rotates to avoid the second engaged part 48. Therefore, the second engaging part 52 passes by the second engaged part 48.

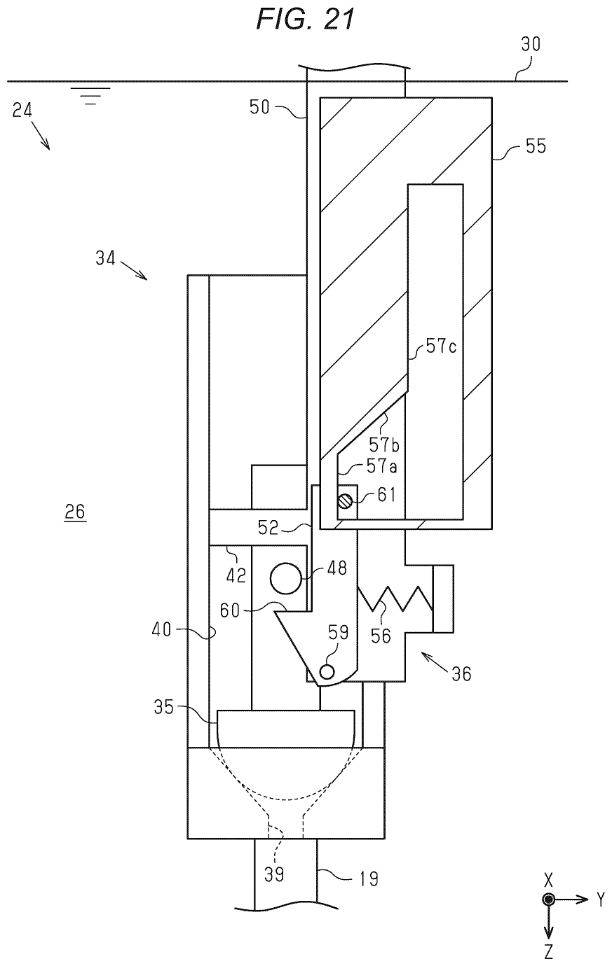

As shown in FIG. 21, when the cover part 23 moves to the closed position, the claw part 60 of the second engaging part 52 is located below the second engaged part 48.

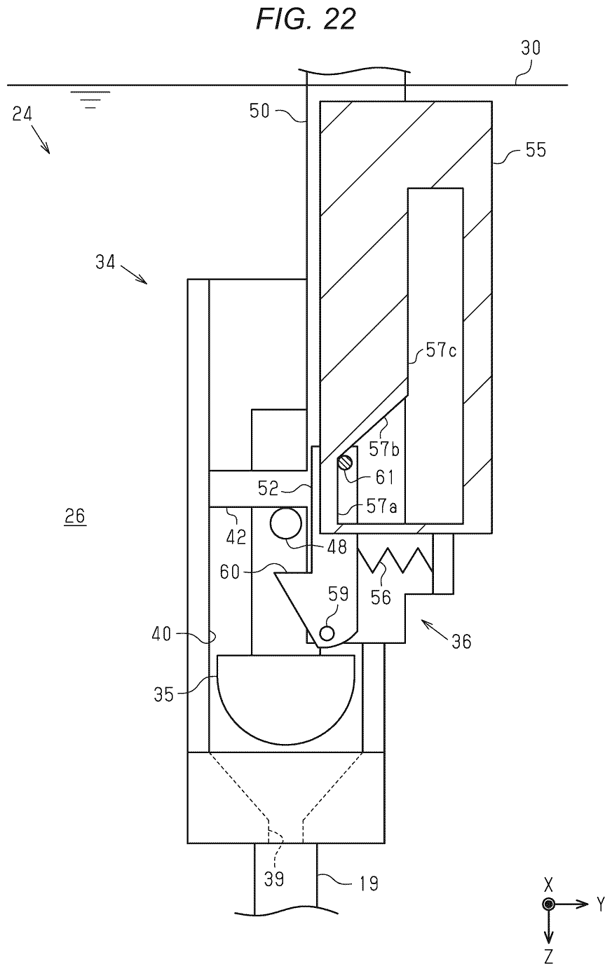

As shown in FIG. 22, when the cover part 23 located at the closed position moves toward the open position, the second engaging part 52 catches the second engaged part 48 and thus lifts up the float valve 35. The float valve 35 separated from the outflow port 39 floats up due to buoyancy and also comes into contact with the regulation part 42 and is thus restricted from moving.

### Effects of Fourth Embodiment

The effects of the present embodiment will be described.

(1-7) After moving the float valve 35 to the opening position, the second engaging part 52 is disengaged from the second engaged part 48. Therefore, the float valve 35 moves to the opening position as the cover part 23 moves, and the position of the float valve 35 can be changed according to the remaining amount of the liquid. Therefore, even when the liquid flows out from the liquid storage unit 18 and the end state is reached while the cover part 23 is located at the open position, the float valve 35 can close the outflow port 39.

### Modification Examples

The present embodiments can be implemented with the modifications described below. The present embodiments and the modification examples given below can be implemented in combination with each other as long as no technical inconsistencies are involved.

In the first embodiment, the upper end of the coupling part 36 may be coupled to a position different from the rotation shaft 32 in the cover part 23. For example, the coupling part 36 may pass through the injection port 27 and be coupled to a part of the cover part 23 that closes the injection port 27. The cover part 23 may be detachably attached to the main body 22.

In each embodiment, the liquid supply unit 13 may include the detection unit 44 and the control unit 45. The detection unit 44 may directly detect the opening and closing of the cover part 23. For example, the detection unit 44 may be a rotary encoder that detects the rotation of the rotation shaft 32. For example, the detection unit 44 may be a contact sensor. For example, the contact sensor may detect the position of the cover part 23 by not coming into contact with the cover part 23 located at the closed position but coming into contact with the cover part 23 located at the open position.

The liquid supply unit 13 may not include the supply pump 20. The liquid supply unit 13 may supply the liquid by the hydraulic head.

The liquid ejection device 11 may be a liquid ejection device that jets or ejects a liquid other than ink. The state of the liquid to be ejected from the liquid ejection device as a minute amount of droplet includes a particle state, a teardrop state, and a state of tailing like a thread. The liquid mentioned here may be any material that can be ejected from the liquid ejection device. For example, the liquid may be any substance in a liquid phase and includes a liquid material high or low in viscosity, sol, gel water, other inorganic solvents, organic solvents, solutions, and a fluid material such as liquid resin, liquid metal, and metal melt. The liquid includes not only a liquid as a state of a substance but also a liquid formed of particles of a functional material made of a solid matter such as a pigment or a metal particle that are dissolved, dispersed, or mixed in a solvent. Representative examples of the liquid include the ink as described in the above embodiments, and a liquid crystal or the like. The term ink includes various types of liquid compositions such as general water-based ink, oil-based ink, gel ink, and hot melt ink. A specific example of the liquid ejection device may be a device that ejects a liquid containing a material such as an electrode material or a coloring material used in, for example, the manufacture of a liquid crystal display, an electroluminescence display, a surface-emitting display, and a color filter, in a dispersed or dissolved form. The liquid ejection device may be a device that ejects a bioorganic substance used for manufacturing a biochip, a device that is used as a precision pipette and ejects a liquid to be a sample, a textile printing device, a micro dispenser, or the like. The liquid ejection device may be a device that ejects lubricating oil to a precision machine such as a timepiece or a camera in a pinpoint manner, or a device that ejects a liquid of transparent resin such as ultraviolet curable resin onto a substrate in order to form a minute hemispherical lens used for an optical communication element or the like, an optical lens, or the like. The liquid ejection device may be a device that ejects an acid or alkali etching solution or the like in order to etch a substrate or the like.

### Definition

The expression “at least one” used in this specification means “one or more” of desired alternatives. For example, the expression “at least one” used in the present specification means “either one of two alternatives” or “both of two alternatives” when the number of alternatives is two. As another example, the expression “at least one” used in the present specification means “only one alternative”, “a combination of any two alternatives”, or “a combination of any three or more alternatives” when the number of alternatives is three or more.

### Appendices

Technical ideas understood from the embodiments and the modification examples described above, and the advantageous effects thereof will be described below.

[1] A liquid storage unit configured to store a liquid includes: an injection port through which to inject the liquid; a cover part configured to open and close the injection port; an outflow port through which to allow the liquid in the liquid storage unit to flow out; a float valve changing in position according to a remaining amount of the liquid in the liquid storage unit, the float valve being configured to close the outflow port when the remaining amount of the liquid is in an end state; and a coupling part having a length in a vertical direction and configured to couple the cover part and the float valve, wherein the float valve moves from a closing position for closing the outflow port to an opening position for opening the outflow port, as the cover part moves from a closed position to an open position.

With this configuration, the coupling part couples the cover part and the float valve. Since the coupling part moves the float valve with the movement of the cover part, the outflow port can be opened without depending on the buoyancy of the float valve. Therefore, for example, even when a small float valve is used, the risk that the outflow port may be left closed can be reduced, and therefore an increase in size can be suppressed.

[2] In the liquid storage unit according to the above [1], the cover part may be displaced by rotating about a rotation shaft, and the coupling part may be provided to be able to be wound up around the rotation shaft.

With this configuration, the cover winds up the coupling part by rotating about the rotation shaft. The coupling part, thus wound up, can pull up the float valve. Therefore, the sticking of the float valve can be released with a simple configuration.

[3] The liquid storage unit according to the above [2] may further include a guide part configured to guide movement of the float valve, and the guide part may include a regulation part that regulates a range of movement of the float valve. With this configuration, the guide part guides the movement of the float valve. The guide part includes the regulation part. The regulation part regulates the range of movement of the float valve. Therefore, the risk of the float valve being detached from the guide part can be reduced.

[4] In the liquid storage unit according to the above [1], the coupling part may include a first engaging part and a second engaging part, the cover part may include a first engaged part that engages with the first engaging part, and the float valve may include a second engaged part that engages with the second engaging part.

With this configuration, the coupling part is engaged with the cover part and the float valve by the first engaging part and the second engaging part. Therefore, the sticking of the float valve can be released with a simple configuration.

[5] In the liquid storage unit according to the above [4], the first engaged part and the second engaged part may be elongate holes, the first engaging part may be a protrusion inserted into the first engaged part, and the second engaging part may be a protrusion inserted into the second engaged part.

With this configuration, the first engaging part is movable along the first engaged part, which is an elongated hole. The second engaging part is movable along the second engaged part, which is an elongated hole. Therefore, the float valve can be moved in a direction different from the direction in which the cover part moves.

[6] In the liquid storage unit according to the above [4], the cover part may be displaced by rotating about a rotation shaft, the first engaged part may be a gear that rotates about the rotation shaft, the first engaging part may be a gear that meshes with the first engaged part, and the coupling part may include a rack that meshes with the first engaging part.

With this configuration, the first engaged part of the cover part is a gear. The first engaging part of the coupling part is a gear that meshes with the first engaged part. The first engaging part meshes with the rack of the coupling part. That is, the coupling part moves when the rotation of the cover is transmitted via the first engaged part, the first engaging part, and the rack. Therefore, the sticking of the float valve can be released with a simple configuration.

[7] The liquid storage unit according to the above [4] may further include: an urging member configured to urge the second engaging part; and a release part configured to move the second engaging part against an urging force of the urging member and thus release the engagement between the second engaging part and the second engaged part, wherein the second engaged part may be a protrusion, the second engaging part may be a claw that catches the second engaged part, and when the cover part moves from the closed position to the open position, the second engaging part may catch the second engaged part to move the float valve to the opening position, and then the release part may release the engagement with the second engaged part.

With this configuration, the second engaging part is disengaged from the second engaged part after the float valve is moved to the opening position. Therefore, the float valve moves to the opening position with the movement of the cover part, and the position of the float valve can be changed according to the remaining amount of the liquid. Therefore, even when the liquid flows out from the liquid storage unit and the end state is reached while the cover part is located at the open position, the float valve can close the outflow port.

[8] A liquid supply unit includes: the liquid storage unit according to any one of the above [1] to [7]; a supply flow path through which the liquid flows out from the liquid storage unit; and a supply pump provided in the supply flow path.

With this configuration, effects similar to those of the liquid storage unit can be achieved.

[9] The liquid supply unit according to the above [8] may further include: a detection unit configured to detect opening and closing of the cover part; and a control unit configured to control the supply pump, wherein the control unit may not drive the supply pump when the detection unit detects that the cover part is located at the open position.

When the cover part is located at the open position, the float valve may not be able to close the outflow port. In this regard, with this configuration, when the cover part is located at the open position, the control unit does not drive the supply pump. Therefore, the risk that the supply pump may suck out air from the liquid storage unit can be reduced.

[10] A liquid ejection device includes: the liquid supply unit according to [8] or [9]; and a liquid ejection unit configured to eject the liquid.

With this configuration, effects similar to those of the liquid storage unit can be achieved.

What is claimed is:

1. A liquid storage unit configured to store a liquid, the liquid storage unit comprising:
an injection port through which to inject the liquid;
a cover part configured to open and close the injection port;
an outflow port through which to allow the liquid in the liquid storage unit to flow out;
a float valve changing in position according to a remaining amount of the liquid in the liquid storage unit, the float valve being configured to close the outflow port when the remaining amount of the liquid is in an end state; and
a coupling part having a length in a vertical direction and configured to couple the cover part and the float valve, wherein
the float valve moves from a closing position for closing the outflow port to an opening position for opening the outflow port, as the cover part moves from a closed position to an open position.

2. The liquid storage unit according to claim 1, wherein
the cover part is displaced by rotating about a rotation shaft, and
the coupling part is to be able to be wound up around the rotation shaft.

3. The liquid storage unit according to claim 2, further comprising:
a guide part configured to guide movement of the float valve, wherein
the guide part includes a regulation part that regulates a range of movement of the float valve.

4. The liquid storage unit according to claim 1, wherein
the coupling part includes a first engaging part and a second engaging part,
the cover part includes a first engaged part that engages with the first engaging part, and
the float valve includes a second engaged part that engages with the second engaging part.

5. The liquid storage unit according to claim 4, wherein
the first engaged part and the second engaged part are elongate holes,
the first engaging part is a protrusion inserted into the first engaged part, and
the second engaging part is a protrusion inserted into the second engaged part.

6. The liquid storage unit according to claim 4, wherein
the cover part is displaced by rotating about a rotation shaft,
the first engaged part is a gear that rotates about the rotation shaft,
the first engaging part is a gear that meshes with the first engaged part, and
the coupling part includes a rack that meshes with the first engaging part.

7. The liquid storage unit according to claim 4, further comprising:
an urging member configured to urge the second engaging part; and
a release part configured to move the second engaging part against an urging force of the urging member and thus release the engagement between the second engaging part and the second engaged part, wherein
the second engaged part is a protrusion,
the second engaging part is a claw that catches the second engaged part, and
when the cover part moves from the closed position to the open position, the second engaging part catches the second engaged part to move the float valve to the opening position, and then the release part releases the engagement with the second engaged part.

8. A liquid supply unit comprising:
the liquid storage unit according to claim 1;
a supply flow path through which the liquid flows out from the liquid storage unit; and
a supply pump provided in the supply flow path.

9. The liquid supply unit according to claim 8, further comprising:
a detection unit configured to detect opening and closing of the cover part; and
a control unit configured to control the supply pump, wherein
the control unit does not drive the supply pump when the detection unit detects that the cover part is located at the open position.

10. A liquid ejection device comprising:
the liquid supply unit according to claim 8; and
a liquid ejection unit configured to eject the liquid.
